(19) United States
(12) Patent Application Publication
(10) Pub. No.: US 2025/0012405 A1
(43) Pub. Date: Jan. 9, 2025

(54) ADAPTIVE FILLING SYSTEM FOR HYDROGEN FUEL TANKS

(71) Applicant: Universal Hydrogen Co., Hawthorne, CA (US)

(72) Inventors: Theophile Coutant, Hawthorne, CA (US); Nick Macdonald, Hawthorne, CA (US); Daniel Costa Blanes, Hawthorne, CA (US); Stephane Valadon, Hawthorne, CA (US)

(21) Appl. No.: 18/389,607

(22) Filed: Dec. 19, 2023

Related U.S. Application Data
(60) Provisional application No. 63/512,542, filed on Jul. 7, 2023.

(51) Int. Cl. F17C 5/00; F17C 5/02; G05B 15/02

(52) U.S. Cl. CPC F17C 5/007; F17C 5/02; G05B 15/02; F17C 2221/012; F17C 2223/0161; F17C 2227/0304; F17C 2250/032; F17C 2250/034; F17C 2250/043; F17C 2250/0615; F17C 2265/065; F17C 2270/0168; F17C 2270/0184; F17C 2270/0189

(57) ABSTRACT

The present disclosure provides adaptive filling systems for use with liquid hydrogen-fuel tank modules. The adaptive filling systems determine, for each tank module, an optimal filling pressure based on passive pressurization due to parasitic heat transfer into the hydrogen-fuel tank during storage and transit. The adaptive filling systems identify a particular hydrogen-fuel tank module, the aircraft it will be loaded onto, the aircraft's estimated time of departure (ETD), the filling time, and the locations of the tank module and the aircraft. The systems fill different hydrogen-fuel tanks at different pressures in order to account for varying periods for storage and transit from the corresponding filling location to the corresponding aircraft or storage location.

### CROSS-REFERENCE TO RELATED APPLICATION

The present application is a U.S. non-provisional patent application that claims the benefit of and priority to U.S. Provisional Patent Application No. 63/512,542, titled ADAPTIVE FILLING SYSTEM FOR HYDROGEN FUEL TANKS, filed Jul. 7, 2023, which is fully incorporated herein by reference thereto.

### TECHNICAL FIELD

The present disclosure relates to filling systems for portable fuel tanks, and more particularly to filling systems for hydrogen-fuel tanks for use with aircraft or other vehicles.

### BACKGROUND

Hydrogen is a clean energy source that can be used to power various vehicles, including aircraft or other vehicles. The hydrogen fuel is typically stored in tanks or other selected vessels as a gaseous fuel or stored at cryogenic conditions in a liquid state. Hydrogen fuel provides a distinct advantage over other types of power sources. For example, aviation gas or jet fuel has specific energies that may generally range from about 43 MJ/kg to about 48 MJ/kg. In contrast, hydrogen has a specific energy of 120-140 MJ/kg. As such, 1 kg of hydrogen can provide the same amount of energy as about 3 kg of gasoline or kerosene. Thus, using hydrogen as a fuel source for vehicles can reduce the fuel weight onboard vehicles while providing a comparable amount of energy as other traditional sources of fuel. Further, consuming hydrogen for fuel may emit benign or nontoxic byproducts, such as water, while eliminating carbon dioxide emissions, thereby reducing the environmental impacts of various modes of transportation that use hydrogen as a fuel source.

Liquid hydrogen is typically stored in vessels under cryogenic conditions. Long term storage of liquid hydrogen in tanks is very challenging and significant amounts of hydrogen can be lost as a result of venting needed to maintain safe pressures within the tanks. This challenge is even more significant for portable tanks that may be usable on aircraft or other vehicles. Accordingly, there is a need for improved filling and storage systems for liquid hydrogen or other fuel stored at cryogenic conditions for use by aircraft or other vehicles.

### SUMMARY

The technology of the present disclosure overcomes drawbacks of conventional technology and provides additional benefits. For example, one or more embodiments of the present technology provide an adaptive filling system for filling reusable, swappable liquid hydrogen storage modules configured to be easily and quickly swapped with other similar liquid hydrogen storage modules. Each storage module has an identifier unique to that module. The adaptive filling system includes a control unit that receives the unique identifier for the associated storage module. For each storage module, the control unit receives a Distribution Cycle Time (“DCT”) corresponding to a storage and transportation period between the module being filled at a filling station and the module being delivered to a designated vehicle. The control unit also receives information about the operational requirement of the vehicle designated to receive the liquid hydrogen storage module. For each identified storage module, the control unit uses the information about the storage module, the DCT information and the designated vehicle operational requirement information, and the control unit calculates a filling pressure and communicates the filling pressure to a filling station. The filling station then fills the designated storage module with liquid hydrogen at the calculated filling pressure. Although minimized by design, the storage modules are not perfectly thermally insulated and are subject to parasitic heat transfer, which leads to a passive pressurization during the transportation and/or storage period. The filling pressure calculated and used at filling is based on the aggregated period of distribution, transportation, and storage, the operational requirements of the end use vehicle, and the passive pressurization rate.

Another embodiment of the present technology provides a method of filling a swappable liquid hydrogen storage tank for use on a hydrogen-powered vehicle. The method includes identifying a first unique identifier associated with the liquid hydrogen storage tank located at a filling location remote from the hydrogen-powered vehicle. The liquid hydrogen storage tank has characteristics that include tank capacity and allowable pressurization levels. A second unique identifier associated with the hydrogen powered vehicle is also identified. The method includes designating the liquid hydrogen storage tank for transportation to and installation and use on the hydrogen powered vehicle via the first and second unique identifiers. Travel schedule information of the hydrogen powered vehicle is determined, wherein the travel schedule information includes an estimated departure time and travel plan. The method includes determining distance and delivery schedule information for the liquid hydrogen storage tank from the filling station to the hydrogen powered vehicle, and determining a storage time period for storing the liquid hydrogen storage tank after receiving liquid hydrogen and before delivery and installation on the hydrogen powered vehicle. The method includes filling the liquid hydrogen storage tank with a selected mass of liquid hydrogen from the filling station based on the tank characteristics, the travel schedule information, the distance and delivery schedule information, and the storage time period, to maximize the mass of hydrogen added to the liquid hydrogen storage tank and to minimize hydrogen fuel loss through venting after filling of the liquid hydrogen storage tank and before delivery of the filled liquid hydrogen storage tank to the hydrogen powered vehicle.

In some embodiments, the filled liquid hydrogen storage tank is transported from the filling station to the hydrogen powered vehicle, and the filled liquid hydrogen storage tank is loaded onto the hydrogen powered vehicle and coupled to a hydrogen fuel system of the hydrogen powered vehicle. The method can include filling the liquid hydrogen storage tank with the liquid hydrogen to an initial fill pressure, transporting the filled liquid hydrogen storage tank from the filling station to the hydrogen powered vehicle, and allowing a pressure in the tank to increase from the initial fill pressure to an elevated second pressure based on pressurization through passive pressurization. In some embodiments, the hydrogen powered vehicle is an aircraft, and the technology includes delivering the filled liquid hydrogen storage tank to the aircraft remote from the filling station. The liquid hydrogen storage tank can be in a swappable fuel module, and filling the liquid hydrogen storage tank includes filling the liquid hydrogen storage tank in the module.

### BRIEF DESCRIPTION OF THE DRAWINGS

A better understanding of the features and advantages of the present disclosure will be obtained by reference to the following detailed description that sets forth illustrative embodiments, in which the principles of the disclosure are utilized, and the accompanying drawings.

FIG. 1 is a schematic diagram illustrating a hydrogen fuel network including an adaptive filling system in accordance with one or more embodiments of the present technology.

FIG. 2 is a schematic diagram illustrating the adaptive filling system in an operative environment in accordance with embodiments of the present technology.

FIG. 3 is a schematic flowchart of the adaptive filling system in accordance with embodiments of the present technology.

FIG. 4 is a schematic timing diagram of an adaptive filling system's operation in accordance with embodiments of the present technology.

FIG. 5 is a schematic diagram of an active pressurization system in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

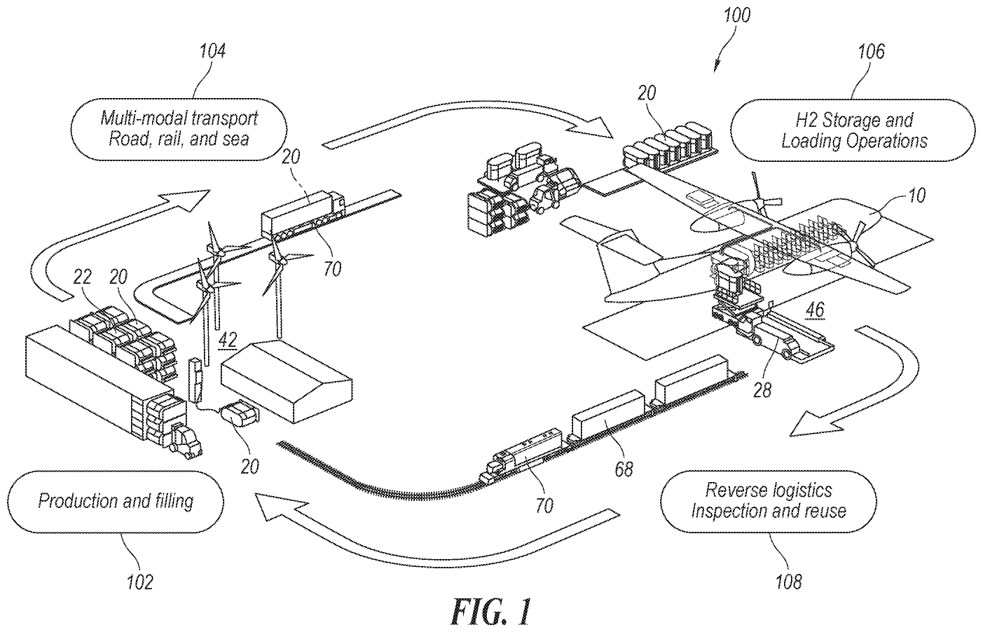

The present technology is directed to adaptive filling systems configured for use with swappable liquid hydrogen storage tanks or other portable storage tanks with fuel typically stored in cryogenic conditions. Specific details of the present technology are described herein with respect to FIGS. 1-5. Although many of the embodiments are described with respect to portable, liquid hydrogen storage tank assemblies and systems, it should be noted that other applications and embodiments in addition to those disclosed herein are within the scope of the present technology. Further, embodiments of the present technology can have different configurations, components, and/or procedures than those shown or described herein. Moreover, a person of ordinary skill in the art will understand that embodiments of the present technology can have configurations, components, and/or procedures in addition to those shown or described herein and that these and other embodiments can be without several of the configurations, components, and/or procedures shown or described herein without deviating from the present technology.

While various embodiments of the present technology are shown and described herein, it will be obvious to those skilled in the art that such embodiments are provided by way of example only. Numerous variations, changes, and substitutions may occur to those skilled in the art without departing from the scope of the present technology. It should be understood that various alternatives to the embodiments described herein may be employed. Further, components disclosed in connection with one or more of the described embodiments may be included or usable in or with other embodiments even if not specifically shown or described. Some components described or shown in connection with an embodiment may not be required and may be excluded while still being within the scope of the applicant's inventive technology.

Conventional liquid hydrogen tanks are typically filled to a selected level and managed in cryogenic conditions until the tanks can be used. The tanks must be managed to try to control tank pressure at or below acceptable levels, which typically requires venting hydrogen from the tanks to reduce the tank pressure. This venting of the tanks, however, results in boil-off losses of gaseous hydrogen, which corresponds to fuel loss. Accordingly, dormancy of the tank (i.e., the time that a tank can be stored before use of the hydrogen) can be improved by filling tanks with liquid hydrogen at low pressures (e.g., a filling pressure of about 1.5 bar). Hydrogen-powered fuel cells usable to power an aircraft or other vehicle, however, often require that the hydrogen be delivered to the fuel cell in a gaseous state at much higher operational pressures (e.g., between 6 bar and 7 bar). Therefore, the pressure of the hydrogen fuel within the tanks must be increased to close to the operational pressure at least before the hydrogen is provided to the fuel cell on the aircraft or other vehicle. The problem of filling and storing the portable, liquid hydrogen storage tanks is exacerbated when tank filling and/or storage facilities are remote from the aircraft on which the portable tank will be used because storage and/or transport times are increased.

Embodiments of the present technology provide an adaptive filling system configured to closely track, monitor, and optimize the filling or refilling of swappable liquid hydrogen storage tank assemblies, storing the filled tank assemblies, and delivering the tank assemblies to an aircraft or other vehicle in accordance with a timeline based on predetermined, individualized information about tank identification, location, conditions, and scheduled use. The system is configured to obtain and use information about the tanks along with external information for use with a liquid hydrogen filling system to specifically fill liquid hydrogen tanks based on defined, determined, and forecasted use, so as to maximize the fuel mass with which the tank assemblies are filled or refilled, while also minimizing the need for active pressurization before usage of the tank in the aircraft. The system with its swappable storage modules is also configured to optimize dormancy in favor of hydrogen mass storage and minimizing fuel loss from venting during for each determined specific use case of the identified storage module and the designated hydrogen-powered aircraft. The system is also configured to allow for delivery of the liquid hydrogen storage tank assemblies to a remote designated hydrogen-powered vehicle with a tank pressure substantially at or close to a designated operational fuel pressure by the time the tank assemblies are loaded onto the vehicle and removably connected to the fuel system. The system is also configured to fill or refill the tank assemblies based upon the extent of passive pressurization that can occur in the swappable liquid hydrogen storage tanks during storage and transport due to parasitic heat transfer through the tank to the hydrogen fuel.

In some embodiments, the adaptive filling system identifies a wide range of applicable information, such as information about selected identifiable, swappable liquid hydrogen storage tanks, the hydrogen-powered aircraft on which the tanks will be used, the aircraft's schedule (including the location and estimated time of departure [ETD]), the tanks' anticipated filling times, the filling/storage location(s), and the estimated distance and time for transport of the filled tanks to the aircraft's location, the DCT for the designated module, the loading time for installation onto the aircraft prior to the ETD, and other external information that may be relevant to the tank pressures and other conditions. The system uses this information and determines the optimal fill characteristics for the identified tank(s) in order to fill or refill the tanks with a maximum mass of liquid hydrogen at the filling location remote from the aircraft in view of the associated DCT, while controlling the dormancy and fuel loss through venting and pressure management, so as to optimize each specific use case of the swappable liquid hydrogen storage modules.

FIG. 1 is a schematic diagram illustrating an embodiment of a hydrogen fuel network 110 that has an adaptive filling system 100 for use with hydrogen fuel storage modules 20 in accordance with embodiments of the present technology. The hydrogen fuel storage modules 20 include one or more swappable, refillable/reusable, liquid hydrogen storage tanks 22 configured to store the liquid hydrogen substantially in cryogenic conditions. The fuel storage modules 20 can include the modules and components described in U.S. Pat. No. 11,525,544, titled Fuel Storage Module Assembly, which is incorporated herein in its entirety by reference thereto. The liquid hydrogen storage tanks 22 can be of the type described in U.S. Patent Application Publication No. 2022-0136656, titled Systems and Methods for Storing Liquid Hydrogen, which is also incorporated herein in its entirety by reference thereto.

The illustrated hydrogen fuel network 110 includes a filling stage 102 at which the tanks 22 of the storage modules 20 are filled with a determined mass of liquid hydrogen at a filling station 42. The filling stage 102 can include a hydrogen production facility, so that the liquid hydrogen can be produced and filled into the modules 20 at substantially the same location. The illustrated hydrogen fuel network 110 also includes a multi-modal transport stage 104, during which the filled storage modules 20 are transported to one or more predetermined destinations on one or more transport vehicles 70 via road, rail, and/or sea. The hydrogen fuel network 110 may further include a module loading operation stage 106, during which the filled storage modules 20 are loaded into one or more hydrogen powered vehicles, such as aircraft 10, at a loading station 46 (e.g., an airport). This loading operation stage can be configured to use standard, commercially available equipment, such as ground support loading vehicles 28. The loading station 46 can be located remote from the filling station 42. The hydrogen fuel network 110 may further include a reverse logistics stage 108, during which one or more depleted or partially spent fuel storage modules 20 are loaded off the aircraft or other vehicle, transported on transport vehicles 68 and 70, inspected, and approved for refill and/or reuse at a selected filling station.

The adaptive filling system 100 can operate at the filling station 42 during the production and filling stage 102. As will be described in further detail below, the adaptive filling system 100 is configured to determine and implement filling of the reusable liquid hydrogen storage tanks 22 with a maximum mass of hydrogen fuel at a determined filling pressure. The system is also configured to minimize hydrogen fuel loss due to venting before the storage modules 20 are loaded onto the designated aircraft and connected to the on-board fuel system and powertrains. This maximizes the amount of hydrogen fuel available to the aircraft, thereby maximizing the travel range of the aircraft, even though the liquid hydrogen storage tanks may be filled remotely and transported up to a long distance to the aircraft.

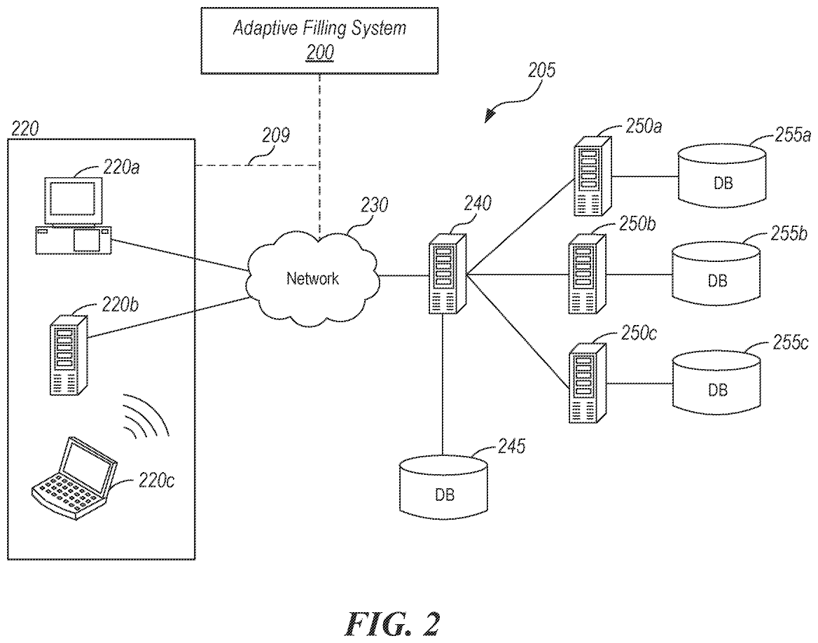

FIG. 2 is a schematic diagram illustrating an adaptive filling system 100 in an operative environment 105 in accordance with embodiments of the present technology. The components of the adaptive filling system 100 communicate, via a direct wired or wireless communication link 109 or a network 130, with each other, with the hydrogen filling station 42, and/or other external information sources. For example, with one or more communication devices 120, which can include sensors, processors, controllers, memories, etc. For example, the communication devices may include a computer, such as a desktop computer 120A, a computer system 120B, a laptop computer 120C, etc. that can include a controller with a central processing unit (CPU) that receives and interprets signals (e.g., digital signals) from sensors using a conventional communication protocol. These are only examples of some of the devices, and other embodiments can include other communication devices, such as personal and/or mobile computing devices. The communication devices 120 can be located at or associated with the various portions of the hydrogen fuel network 110. For example, a communication device 120 may be on or associated with the transport vehicles 70, and the adaptive filling system 100 may receive information related to the specific hydrogen storage modules 20 that the transport vehicles 70 are or will be carrying, a transportation plan (e.g., navigation route), and/or real-time traffic information from the communication device 120. The adaptive filling system 100 can then communicate with the communication device 120 a new or altered list of hydrogen storage modules 20 to be transported, a new or altered transportation plan, and/or real-time directions (e.g., change in destination from an airport to a storage facility).

As another example, a communication device 120 may be on or associated with the loading station 46 and/or the vehicle 10, and the adaptive filling system 100 may receive information related to the specific hydrogen storage modules 20 that the vehicle 10 will be loaded with, real-time flight schedule information (e.g., gate location, anticipated delays), and/or operational requirements of the vehicle 10 (e.g., total amount of hydrogen fuel needed for the flight, hydrogen pressure requirements). The adaptive filling system 100 can then communicate to the communication device 120 an estimated hydrogen fuel storage module loading time and/or real-time information related to the amount of hydrogen fuel in the particular hydrogen storage modules 20 and/or tanks 22 to be loaded onto the vehicle 10.

As another example, a communication device 120 may be on or associated with a particular hydrogen storage module 20 or tank 22, and the adaptive filling system 100 may receive information related to the module's unique identifier, current location, and/or real-time hydrogen storage level. In yet another example, a communication device 120 may be at or associated with the filling station 42, and the adaptive filling system 100 may receive information related to the filling schedule of particular hydrogen storage modules 20 and/or real-time information related to the operational capacity of the filling station 42. The adaptive filling system 100 can then communicate to the communication device 120 an optimized filling pressure for a particular hydrogen storage module 20 and cause the module 20 to be filled with liquid hydrogen at the filling station 42.

Alternatively, or additionally, the communication devices 120 collect various data from the network 130 (e.g., aircraft gate location, aircraft estimated time of departure [ETD], traffic data between a tank module filling location and the airport) and communicate the collected data to the adaptive filling system 100 and/or a service provider (e.g., a remote device/system, such as a server). The collected data can be leveraged for determining the transit and storage period and the optimal filling pressure. For example, the adaptive filling system 100 includes a control unit programmed to provide filling, transit, and storage instructions based on real-time ground, airport, and air traffic data. The communication devices 120 can also communicate information, such as the tank module's estimated time of arrival (ETA) and tank pressure data, from the adaptive filling system 100 and/or the service provider to the aircraft and airport. In some embodiments, the adaptive filling system 100 utilizes a computing device configured for use with a computer-implemented system for filling a portable liquid hydrogen fuel storage tank for use on a hydrogen powered vehicle. The computer-implemented system can include an electronic storage medium comprising computer-executable instructions and one or more processors in electronic communication with the electronic storage medium and configured to execute the computer-executable instructions.

The computing devices on which the disclosed systems are implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the technology, e.g., a computer-readable medium that contains the instructions. In addition, the instructions, data structures, and message structures may be stored or transmitted via a data transmission medium, such as a signal on a communications link and may be encrypted. Non-transitory computer-readable media include tangible media such as storage media, hard drives, CD-ROMs, DVD-ROMS, and memories such as ROM, RAM, and Flash memories that can store instructions. Signals on a carrier wave such as an optical or electrical carrier wave are examples of transitory computer-readable media. Furthermore, “computer-readable devices” includes input, output, storage, and other devices but does not include transitory, propagating signals. Various communications links may be used, such as the Internet, a local area network, a wide area network, a point-to-point dial-up connection, a cell phone network, and so on.

The disclosed systems may be described in the general context of computer-executable instructions, such as program modules, executed by one or more computers or other devices. Generally, program modules include routines, programs, objects, components, data structures, and so on, that perform particular tasks or implement particular abstract data types. Typically, the functionality of the program modules may be combined or distributed as desired in various embodiments.

Many embodiments of the technology described herein may take the form of computer-executable instructions, including routines executed by a programmable computer. Those skilled in the relevant art will appreciate that aspects of the technology can be practiced on computer systems other than those shown and described herein. Embodiments of the technology may be implemented in and used with various operating environments that include personal computers, server computers, handheld or laptop devices, multiprocessor systems, microprocessor-based systems, programmable consumer electronics, network PCs, minicomputers, mainframe computers, computing environments that include any of the above systems or devices, and so on. Moreover, the technology can be embodied in a special-purpose computer or data processor that is specifically programmed, configured or constructed to perform one or more of the computer-executable instructions described herein. Accordingly, the terms “computer” or “system” as generally used herein refer to any data processor and can include Internet appliances and handheld devices (including wearable computers, cellular or mobile phones, multi-processor systems, processor-based or programmable consumer electronics, network computers, mini computers and the like). Information handled by these computers can be presented at any suitable display medium, including, but not limited to, a cathode ray tube display, liquid crystal display, light emitting diode display, plasma display, etc.

The technology can also be practiced in distributed environments, where tasks or modules are performed by remote processing devices that are linked through a communications network. In a distributed computing environment, program modules or subroutines may be located in local and remote memory storage devices. Aspects of the technology described herein may be stored or distributed on computer-readable media, including magnetic or optically readable or removable computer disks, as well as distributed electronically over networks. Data structures and transmissions of data particular to aspects of the technology are also encompassed within the scope of the technology. For example, various systems may transmit data structures and other information using various protocols, such as the hypertext transfer protocol (HTTP), the transmission control protocol (TCP), the ZigBee protocols, etc.

The communication devices 120 can operate in a networked environment using logical connections through network 130 to the adaptive filling system 100 and/or one or more remote computers, such as a server computing device or a cloud computing environment. The networked environment can also be used to provide software updates to algorithms used in the adaptive filling system 100 and/or the one or more client computing devices. In some embodiments, the server 140 can be an edge server which receives client requests and coordinates fulfillment of those requests through other servers, such as servers 150A-C. Server computing devices 140 and 150 can include computing systems. Though each server computing device 140 and 150 is displayed logically as a single server, server computing devices can each be a distributed computing environment encompassing multiple computing devices located at the same or at geographically disparate physical locations. In some implementations, each server 150 corresponds to a group of servers.

Client computing/communication devices 120 and server computing devices 140 and 150 can each act as a server or client to other server/client devices. Server 140 can connect to a database 145. For example, the servers 150A-C can each connect to a corresponding database 155A-C. As discussed above, each server 150 can correspond to a group of servers, and each of these servers can share a database or can have their own database. Databases 145 and 155 can warehouse (e.g., store) information (e.g., real-time flight schedule, operational requirements of various aircraft 10), and the adaptive filling system 100 can receive such information through the network 130. Though databases 145 and 155 are displayed logically as single units, databases 145 and 155 can each be a distributed computing environment encompassing multiple computing devices, can be located within their corresponding server, or can be located at the same or at geographically disparate physical locations.

Network 130 can be a local area network (LAN), a wide area network (WAN), and/or other wired, wireless, or combinational networks. Portions of network 130 may be the Internet or some other public or private network. Communication devices 120 can be connected to network 130 through a network interface, such as by wired or wireless communication. While the connections between server 140 and servers 150 are shown as separate connections, these connections can be any kind of local, wide area, wired, or wireless network, including network 130 or a separate public or private network.

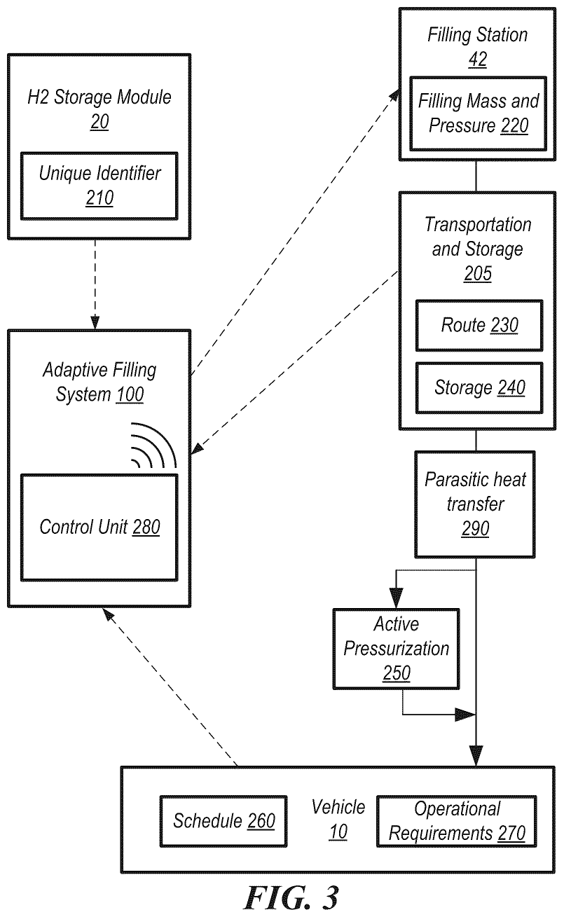

FIG. 3 is a schematic flowchart of operations of the adaptive filling system 100 in accordance with one or more embodiments of the present technology. The adaptive filling system 100 communicates with or otherwise receives information from multiple portions of the hydrogen fuel network 110 (FIG. 1) through the operative environment 105 (FIG. 2), including the hydrogen-powered aircraft 10 (e.g., the aircraft), the airport facility 46, the hydrogen fuel storage modules 20, the filling station 42, the transportation and storage plan 205, etc. The adaptive filling system 100 can also receive relevant information from external sources, such as information about current or forecasted weather conditions, road conditions, airport conditions, transport vehicle conditions, etc. The adaptive filling system 100 uses the information to specifically match a selected aircraft 10 with one or more uniquely identifiable hydrogen fuel storage modules 20. The system 100 is also configured to determine how much liquid hydrogen can be filled into the tanks at the filling station, so that a maximum mass of hydrogen fuel will remain in the tanks at a designated pressure by the time the modules 20 are transported and delivered to the designated aircraft 10.

For example, each liquid hydrogen storage module 20 has a unique identifier 210, which also corresponds to the particular characteristics of the module, such as the tank volume, the maximum pressures, the relief venting pressures, etc. The aircraft 10 onto which a designated hydrogen fuel storage module 20 will be loaded will have a specified flight schedule 260, including estimated arrival time at a designated airport, the flight plan from the airport to an identified destination, an estimated departure time from the airport, travel duration, minimum fuel requirements, etc. The hydrogen fuel system of the aircraft 10 can have operational requirements 270, such as a hydrogen fuel pressure of between 6 and 8 bar required for startup and operation of the fuel cells in the aircraft's powertrains, etc. The adaptive filling system 100 uses the information from and about the designated modules, the filling station, the designated vehicle, other external information, etc. to determine the filling mass and pressure 220 of the liquid hydrogen, etc.

When the module 20 is filled with liquid hydrogen at the filling station 42, it is desirable to fill the tank with a maximum mass of hydrogen at a determined lower filling pressure 220 for improving storage conditions of the hydrogen fuel while avoiding or minimizing the amount of venting needed before the module 20 is delivered to aircraft 10. Accordingly, to minimize fuel loss while still meeting the schedule 260 and operational requirements 270 of the aircraft 10, it is important to calculate an optimal filling mass and pressure 220. During transit and storage of the module 20 between the filling station 42 and the aircraft 10, the hydrogen pressure will passively increase duc to parasitic heat transfer 290 from the environment into the module 20. The adaptive filling system 100 can use this passive pressurization to raise the hydrogen pressure from the filling pressure 220 to the operational requirement 270 by the time the module 20 is delivered to the designated aircraft, thereby avoiding or reducing the need for, for example, heaters or other external heating systems, which require energy, to increase the pressure of the hydrogen to within the operational range for the vehicle 10.

The adaptive filling system 100 includes one or more control units 280 operably coupled to the filling station 42. The control units 280 are also configured to receive data regarding a particular hydrogen fuel storage module 20, the vehicle 10 onto which the particular hydrogen fuel storage module 20 will be loaded, and the module's transportation and storage plan 205. For example, the unique identifier of the particular hydrogen fuel storage module 20 is communicated to the control unit 280. The transportation and storage plan 205 can have a predetermined transit route 230, including traffic data, from which a transit time can be computed, and a storage period 240 during which the particular hydrogen fuel storage module 20 is stored. For example, the transportation and storage plan 205 may avoid transporting the module 20 during rush-hour, which can introduce uncertainty to the transit time, and instead transport the module 20 earlier and store the module 20 at an airport facility. The transit and storage times can add to the module's dormancy period. The aircraft 10 can have a schedule (e.g., flight schedule) 260 and operational requirements (e.g., hydrogen pressure requirements) 270. For example, the flight schedule 260 can include a departure time, gate location, and destination, and the hydrogen pressure requirement can range between 6 and 8 bar. Other data communicated to the control unit 280 can include real-time airport and air traffic data and weather data, which can affect transit time and the departure time. The control unit 280 can receive these data via the operative environment 105 described above with respect to FIG. 2 (e.g., by communicating with various communication devices 120 associated with the portions of the hydrogen fuel network 110). The adaptive filling system 100, such as via its one or more control units 280, uses the received or collected information and communicates with the filling station 42 regarding the uniquely identified tank(s) of the module 20 and causes or otherwise directs the filling station 42 to fill or refill the associated tank or tanks 22 in the identified module 20 with the designated mass of liquid hydrogen to maximize the amount of hydrogen fuel that will be contained in the module by the time the module is delivered and/or installed into the predetermined aircraft of other vehicle 10.

At the end of the storage and transit period, and when the module 20 is loaded onto the aircraft 10, if the parasitic heat transfer 290 failed to sufficiently raise the hydrogen fuel pressure enough relative to the operational requirements 270 of the aircraft 10, an active pressurization system 250 can be activated and used to quickly raise the pressure as needed to activate the aircraft's fuel cells in the powertrain.

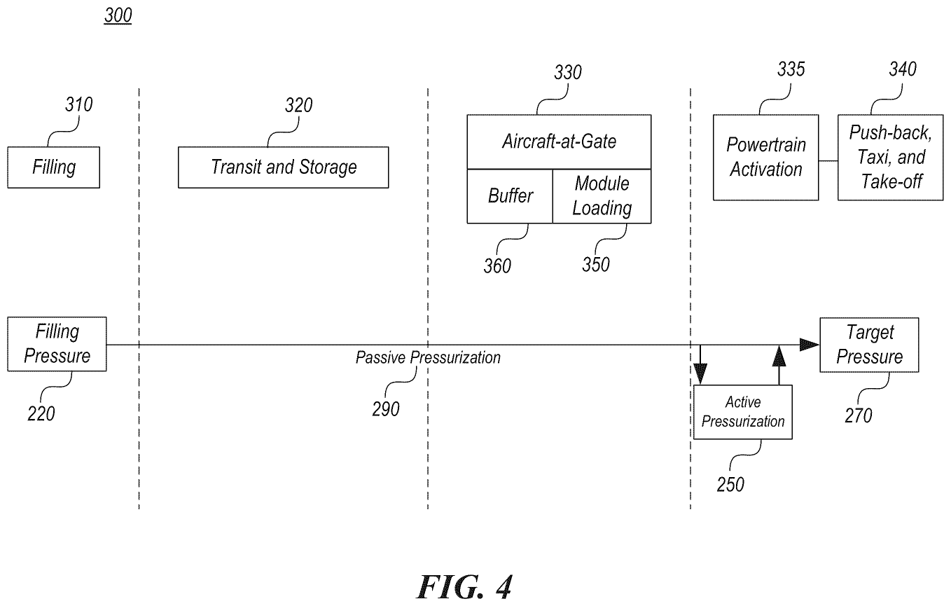

FIG. 4 is a schematic timing diagram 300 in which the adaptive filling system 100 operates in accordance with embodiments of the present technology. The adaptive filling system 100 computes the filling pressure 220 by taking the difference between the target pressure 270 (e.g., the operational pressure requirement of the aircraft 10) and the passive pressurization 290 expected during the dormancy period due to parasitic heat transfer. The passive pressurization 290 can be calculated by multiplying the rate of parasitic heat transfer, which may be a known value or function, and the length of the dormancy period. Therefore, it is important that the adaptive filling system 100 accurately determine the length of the dormancy period and the various factors that may affect the dormancy period. The schematic timing diagram 300 includes a filling period 310, a storage and transit period 320, an aircraft-at-gate period 330, and a push-back, taxi, and take-off period 340. The dormancy period can include the storage and transit period 320 and/or the aircraft-at-gate period 330. In other embodiments, the timing diagram 300 has fewer, more, or alternative periods.

During the filling period 310, an identified storage module 20 is to be filled with liquid hydrogen at the computed filling pressure 220 at the filling station 42. In some embodiments, the storage module 20 is filled with as much liquid hydrogen as possible while meeting safety requirements, which can be affected by the filling pressure 220. The adaptive filling system 100, however, enables identified modules 20 to be filled with enough liquid hydrogen as needed for the designated aircraft 10, while also allowing for the designated storage period, so the modules 20 and filling station 42 do not have to maintain a real-time “fill-on-demand” system.

During the storage and transit period 320, the storage module 20 is transported to either the aircraft 10 (e.g., a specific gate at an airport) or a storage location at which the tank module is to be stored until the aircraft is ready to receive the storage module 20. The adaptive filling system 100 can incorporate logistics to coordinate a transit network and a predetermined transit route. During the storage and transit period 320, the storage module 20 undergoes passive pressurization 290 due to parasitic heat transfer into the storage module 20. The duration of the storage and transit period 320 can vary widely depending on the distance between the filling station 42 and the aircraft 10, weather conditions, traffic conditions, etc. In some embodiments, the tank module insulation, the cryogenic conditions of the tank module, and the storage and transit conditions (e.g., pressure and temperature) are configured such that the rate of passive pressurization is known or determinable. The adaptive filling system 100 can account for other factors that affect the rate of passive pressurization, such as manufacturing dispersions, vacuum quality, and sloshing effects. In some embodiments, the rate of pressurization during dormancy ranges between 0.05 bar/hour and 0.2 bar/hour, or more narrowly between 0.1 bar/hour and 0.15 bar/hour.

During the aircraft-at-gate period 330, the aircraft designated to receive the one or more particular hydrogen fuel storage modules 20 may be positioned at an airport gate and undergo the loading of luggage/freight, passengers, and/or crew. The storage module 20 may continue to undergo passive pressurization 380 during the aircraft-at-gate period 330. In some embodiments, the aircraft-at-gate period 330 is about 20 minutes. The one or more designated storage modules 20 are loaded onto the aircraft during a module loading period 350 within the aircraft-at-gate period 330. The storage modules 20 may not need to be at the target pressure 270 during the module loading period 350, because there may be a buffer period 360 prior to the module loading period 350 during which passive pressurization may continue to occur. The buffer period 360 is configured to avoid unwanted triggering of the pressure relief device in case of delay with the expected storage and transportation time.

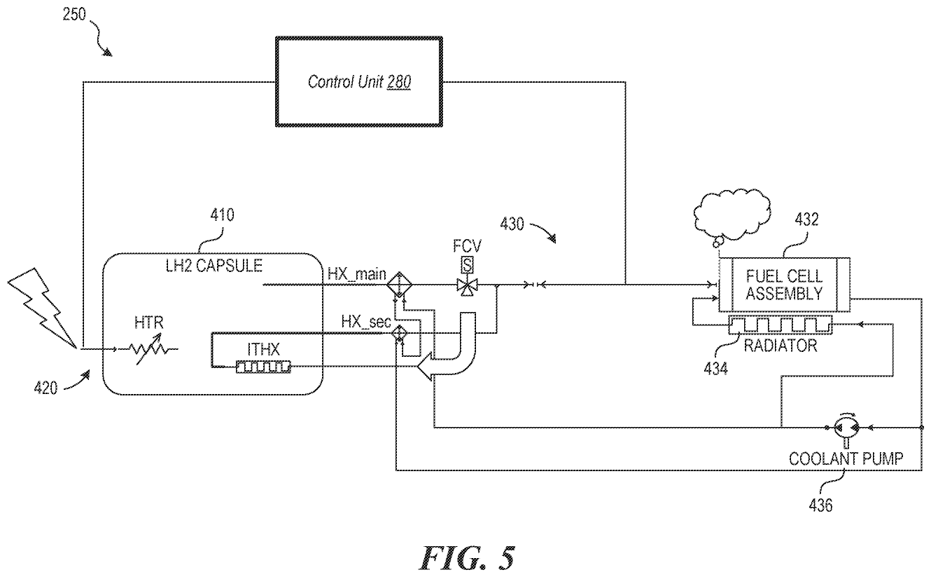

Once the one or more designated storage modules 20 are loaded onto the aircraft 10, the modules should be at or close to the elevated target pressure of the hydrogen fuel in the tanks for activation and operation of the aircraft's fuel cells in the powertrain. In some embodiments, the powertrain system can be a system or components thereof as described in U.S. Pat. No. 11,420,757, titled Systems and Methods for Multi-Module Control of a Hydrogen Powered Hybrid Electric Powertrain, which is also incorporated in its entirety herein by reference thereto. For this embodiment, the elevated target powertrain system requires a target pressure at the outlet of the tank of approximately 6-8 bar, and in at least one embodiment approximately 6.5 bar, so as to provide hydrogen fuel to the powertrain at approximately 5 bar. The adaptive filling system 100 can be configured to allow the storage module 20 to continue undergoing some passive pressurization 290 during a buffer period 360 relative to activation of the powertrain 335 prior to a push-back, taxi, and take-off period 340, which typically has a duration of about 15 minutes. Accordingly, the adaptive filling system 100 uses this anticipated timing sequence during the aircraft-at-gate 330, buffer 360, and push-back, taxi, and take-off period 340 in determining the filling process 310 for the predetermined modules 20 when at the filling station. If the tank pressure is over a pressure threshold for the tank, the fuel cells of the aircraft's powertrain can be activated. Alternatively, the module 20 can be briefly vented to lower the tank pressure if needed. If the tank pressure is below, the module 20 can be actively pressurized (e.g., via the active pressurization system 250) to achieve the targeted operational pressures needed by the powertrain. Examples of active pressurization methods are illustrated in FIG. 5.

An example of operation of the adaptive filling system 100 with reference to FIG. 3 follows for illustration purposes. In one embodiment, the adaptive filling system 100 can be used to service a hydrogen-powered ATR 72 aircraft 10 with powertrains having fuel cells with operational pressure requirements of about 6.5 bar. If the liquid hydrogen filling station 42, for example, is located in Madrid and the aircraft 10 is to depart from San Sebastian Airport, the adaptive filling system's control unit 280 will allot a road transit period from the filling station to the airport of 8 hours and a module storage period of 12 hours after filling the designated tanks at the filling station. For the designated one or more modules 20, the rate of passive pressurization 290 for each tank is known to be approximately 0.15 bar/hour, and the passive pressure increase during the total storage and transit period of 20 hours will be 3.0 bar. Therefore, the controller of the adaptive filling system 100 will determine that the filling pressure 220 must be approximately 3.5 bar (i.e., operational pressure-passive pressure increase). In another example, if the same aircraft 10 is to depart from Madrid Airport, the same identified and designated modules may be filled or refilled at a different filling station that is much closer to the airport. The controller 28 of the adaptive filling system 100 uses the relevant information (i.e., information about the tanks/modules, weather conditions and forecasts, road conditions, airport conditions, aircraft information, flight plan information, etc.). The controller 28 allots a transit period of 1 hour for the modules from the liquid hydrogen filling station to the airport, and the controller 28 allots no storage period after the tanks are filled with the liquid hydrogen (i.e., the modules are transported to the airport as soon as the tanks are filled). In this example, the controller 28 uses this relevant information received and determines that the passive pressure increase during the transit period will be 0.15 bar, so the controller determines that the filling pressure must be approximately =6.35 bar (i.e., 6.5 bar operational-0.15 bar passive pressure increase). The controller then communicates to the filling station and causes the filling station to fill or refill the tanks of uniquely identified, designated modules to a fill pressure of 6.35 bar. In the examples above, the mass of the hydrogen filled into the tanks is maximized compared to a constant filling pressure, because in the first example the tanks were filled so as to avoid venting hydrogen from the tank prior to delivery and installation on the vehicle. In the second embodiment, the tanks were filled at a pressure so as to avoid the need for active pressurization upon delivery and installation on the vehicle.

FIG. 5 is a schematic of an active pressurization system 250 in accordance with embodiments of the present technology. The active pressurization system 250 includes the control unit 280 (or a different control unit) with one or more processors, and a pressurization assembly couplable to a tank module 410. Unexpected circumstances (e.g., related to transit, logistics, etc.) may cause storage modules 20 filled according to the adaptive filling system 100 to be under the target pressure 270. In order to avoid delaying flights, the active pressurization system 250 can be used to quickly raise the tank pressure to the target pressure 270 once the module 20 is loaded onto the aircraft 10 and prior to takeoff. For example, the control unit 280 can cause the pressurization assembly to pressurize the tank module 410 at an active pressurization rate that is greater than the passive pressurization rate. While the active pressurization system 250 provides the benefit of rapid pressurization, the system 250 may provide additional components, which may use an external power source for some of the components.

One method of active pressurization of the hydrogen in the tanks is by using the pressurization assembly comprising a heater system 420 (e.g., an electric heater) configured to add heat to components of the tank module 410, such as to the tank or the hydrogen fuel lines, for activated heat transfer at a higher rate than the parasitic heat transfer. This can be an effective method for controllably increasing the pressure of the hydrogen, particularly in low-pressure conditions. However, it can be less efficient than hydrogen recirculation and more energy intensive. Moreover, the heater system 420 typically requires an additional power source to operate the heater.

Another method of active pressurization is using the pressurization assembly comprising a hydrogen recirculation system 430, which includes a closed loop with a fuel cell assembly 432, a radiator 434 configured to cool the fuel cell assembly 432, and a coolant pump 436 configured to circulate a coolant such as water or a water-glycol mixture in order to remove excess heat. The hydrogen recirculation system 430 extracts hydrogen from the tank module 410 and the hydrogen is warmed by heat from the warm coolant. A portion of the warm, unused hydrogen is recycled back to the tank module 410 to help regulate the temperature and pressure of the hydrogen fuel. That hydrogen is warmed again and redirected to the fuel cell assembly 432. Accordingly, the only heat coming from the powertrain is from the warm coolant. This can be a more efficient method for increasing pressure, as it only requires heating a small portion of the hydrogen at a time. Additionally, the hydrogen recirculation system 430 can help to maintain a consistent supply of hydrogen to the fuel cell, as any fluctuations in pressure or temperature can be quickly corrected. In addition, heat from the warmed hydrogen helps to cool the fuel cell assembly 432. However, the hydrogen recirculation system 430 requires the aforementioned components, adding cost and complexity, and also possibly fuel loss.

In some embodiments, the adaptive filling system 100 includes the active pressurization system 250. In some embodiments, the active pressurization system 250 is used in conjunction with the passive pressurization system at all times based on evolving real-time transit, storage, and flight schedule conditions. In some embodiments, the adaptive filling system 100 may be configured for use with the active pressurization system 250 as a backup system once the designated module is loaded on to the aircraft in case the time is too short to allow a passive pressurization system to sufficiently raise the pressure to the target pressure 270 to the desired range.

While preferred embodiments of the present disclosure have been shown and described herein, it will be obvious to those skilled in the art that such embodiments are provided by way of example only. It is not intended that the disclosure be limited by the specific examples provided within the specification. While the disclosure has been described with reference to the aforementioned specification, the descriptions and illustrations of the embodiments herein are not meant to be construed in a limiting sense. Numerous variations, changes, and substitutions will now occur to those skilled in the art without departing from the disclosure. It shall be understood that all aspects of the disclosure are not limited to the specific depictions, configurations, or relative proportions set forth herein, which depend upon a variety of conditions and variables. It should be understood that various alternatives to the embodiments of the disclosure described herein may be employed in practicing the disclosure. It is therefore contemplated that the disclosure shall also cover any such alternatives, modifications, variations, or equivalents. It is intended that the following claims define the scope of the disclosure and that methods and structures within the scope of these claims and their equivalents be covered thereby.

We claim:

1. An adaptive filling system for filling liquid hydrogen fuel storage modules, the system comprising:
liquid hydrogen fuel storage modules transportable to a filling station for filling with liquid hydrogen fuel; and
a control unit operably coupleable to the filling station, wherein the control unit includes one or more processors configured to execute instructions to, for each of the storage modules:
receive a unique identifier, a transportation and storage period between the filling station and a vehicle, and an operational requirement of the vehicle;
determine a filling pressure; and
communicate the determined filling pressure to the filling station,
wherein the storage module with the unique identifier is configured to be filled with liquid hydrogen fuel at the determined filling pressure at the filling station,
wherein the storage modules are configured to be subject to parasitic heat transfer at a passive pressurization rate during the transportation and storage period, and
wherein the filling pressure is determined based on the transportation and storage period, the operational requirement of the vehicle, and the passive pressurization rate.

2. The system of claim 1, wherein the operational requirement of the vehicle is a target hydrogen fuel pressure, and wherein the filling pressure is a difference between (i) the target hydrogen fuel pressure and (ii) a product between the transportation and storage period and the passive pressurization rate.

3. The system of claim 2, wherein the target hydrogen fuel pressure ranges between 6 bar and 8 bar.

4. The system of claim 2, wherein the passive pressurization rate ranges between 0.05 bar/hour and 0.2 bar/hour.

5. The system of claim 2, wherein the passive pressurization rate ranges between 0.1 bar/hour and 0.15 bar/hour.

6. The system of claim 1, wherein the transportation and storage period is based on real-time traffic data between the filling station and the vehicle.

7. The system of claim 1, wherein the control unit is configured to, for each storage module,
receive a schedule of the vehicle; and
determine a time at which the storage module is to be filled with liquid hydrogen fuel at the determined filling pressure at the filling station, wherein the time is based on the schedule of the vehicle and the transportation and storage period.

8. The system of claim 1, further comprising an active pressurization system configured to pressurize the storage module at an active pressurization rate prior to the storage module being loaded onto the vehicle upon determining that the storage module does not meet the operational requirement of the vehicle, wherein the active pressurization rate is greater than the passive pressurization rate.

9. The system of claim 8, wherein the active pressurization system includes a hydrogen recirculation assembly couplable to the storage module and configured to recirculate warmed and compressed hydrogen back into the storage module until the storage module meets the operational requirement of the vehicle.

10. The system of claim 8, wherein the active pressurization system includes an electric heater configured to heat the storage module until the control unit determines that the storage module meets the operational requirement of the vehicle.

11. The system of claim 8, wherein the operational requirement of the vehicle comprises a target hydrogen fuel pressure.

12. A method of a filling a portable liquid hydrogen fuel storage tank for use on a hydrogen powered vehicle, the comprising:
identifying a first unique identifier associated with the liquid hydrogen fuel storage tank located at a filling location remote from the hydrogen powered vehicle, wherein the liquid hydrogen fuel storage tank has tank characteristics that includes tank capacity and allowable pressurization levels;
identifying a second unique identifier associated with the hydrogen powered vehicle;
designating the liquid hydrogen fuel storage tank for transportation to, installation on, and use with the hydrogen powered vehicle via the first and second unique identifiers;
determining travel schedule information of the hydrogen powered vehicle, wherein the travel schedule information includes an estimated departure time and travel plan;
determining distance and delivery schedule information for the liquid hydrogen fuel storage tank from the filling station to the hydrogen powered vehicle;
determining a storage time period for storing the liquid hydrogen fuel storage tank after receiving liquid hydrogen and before delivery and installation on the hydrogen powered vehicle; and
filling the liquid hydrogen fuel storage tank with a selected mass of liquid hydrogen from the filling station based on the tank characteristics, the travel schedule information, the distance and delivery schedule information, and the storage time period, to maximize the mass of hydrogen added to the liquid hydrogen fuel storage tank and minimize hydrogen fuel loss through venting after filling of the liquid hydrogen fuel storage tank and before delivery of the filled liquid hydrogen fuel storage tank to the hydrogen powered vehicle.

13. The method of claim 12, further comprising transporting the filled liquid hydrogen fuel storage tank from the filling station to the hydrogen powered vehicle.

14. The method of claim 13, further comprising loading the filled liquid hydrogen fuel storage tank onto the hydrogen powered vehicle and coupling the tank to a hydrogen fuel system of the hydrogen powered vehicle.

15. The method of claim 12, further comprising filling the liquid hydrogen fuel storage tank with the liquid hydrogen to an initial fill pressure, transporting the filled liquid hydrogen fuel storage tank from the filling station to the hydrogen powered vehicle, and allowing a pressure in the tank to increase from the initial fill pressure to an elevated second pressure based on pressurization through passive pressurization.

16. The method of claim 12 wherein the hydrogen powered vehicle is an aircraft, and further comprising delivering the filled liquid hydrogen fuel storage tank to the aircraft remote from the filling station.

17. The method of claim 12 wherein the liquid hydrogen tank is in a portable fuel module, and filling the liquid hydrogen tank includes filling the liquid hydrogen fuel storage tank in the module.

18. The method of claim 12 wherein the liquid hydrogen fuel storage tank is in a portable, refillable hydrogen fuel tank, and wherein filling the liquid hydrogen fuel storage tank comprising refilling the refillable hydrogen fuel tank that has been previously filled and depleted of liquid hydrogen fuel.

19. The method of claim 12, further comprising determining environmental conditions at the hydrogen powered vehicle's location and the filling station.

20. The method of claim 19 wherein filling the liquid hydrogen fuel storage tank includes filling the liquid hydrogen fuel storage tank with a selected mass of liquid hydrogen also based on the environmental conditions.

21. An active pressurization system, comprising:
a pressurization assembly couplable to a liquid hydrogen fuel storage module, wherein the storage module is configured to be loaded onto a vehicle, and wherein the storage module is subject to parasitic heat transfer at a passive pressurization rate prior to being loaded onto the vehicle; and
a control unit operably coupled to the pressurization assembly, wherein the control unit including one or more processors configured to execute instructions to:
determine that the storage module does not meet an operational requirement of the vehicle prior to the storage module being loaded onto the vehicle; and
cause the pressurization assembly to pressurize the storage module at an active pressurization rate prior to the storage module being loaded onto the vehicle,
wherein the active pressurization rate is greater than the passive pressurization rate.

22. The system of claim 21, further comprising a transportation vehicle configured to transport the liquid hydrogen fuel storage module to the vehicle, wherein the pressurization assembly is mounted on the transportation vehicle.

23. The system of claim 21, wherein the pressurization assembly comprises a hydrogen recirculation assembly configured to extract hydrogen from the storage module and recirculate warmed and compressed hydrogen back into the storage module until the control unit determines that the storage module meets the operational requirement of the vehicle.

24. The system of claim 21, wherein the pressurization assembly comprises an electric heater configured to heat the storage module until the control unit determines that the storage module meets the operational requirement of the vehicle.

25. The system of claim 21, wherein the operational requirement of the vehicle comprises a target hydrogen fuel pressure.

26. A computer-implemented system for filling a portable liquid hydrogen fuel storage tank for use on a hydrogen powered vehicle, the computer-implemented system comprising an electronic storage medium comprising computer-executable instructions and one or more processors in electronic communication with the electronic storage medium and configured to execute the computer-executable instructions in order to:
identify, by the computer-implemented system, a first unique identifier associated with the liquid hydrogen fuel storage tank located at a filling station remote from the hydrogen powered vehicle, wherein the liquid hydrogen fuel storage tank has tank characteristics that includes tank capacity and allowable pressurization levels;
identify, by the computer-implemented system, a second unique identifier associated with the hydrogen powered vehicle;
designate, by the computer-implemented system, the liquid hydrogen fuel storage tank for transportation to, installation on, and use with the hydrogen powered vehicle via the first and second unique identifiers;
receive, by the computer-implemented system, travel schedule information of the hydrogen powered vehicle, wherein the travel schedule information includes an estimated departure time and travel plan; and
determine, by the computer-implemented system, a selected mass of liquid hydrogen, wherein the liquid hydrogen fuel storage tank is configured to be filled with the selected mass of liquid hydrogen,
wherein the selected mass of liquid hydrogen is based on the tank characteristics and the travel schedule information, and
wherein the selected mass of liquid hydrogen is determined to maximize the mass of hydrogen added to the liquid hydrogen fuel storage tank and minimize hydrogen fuel loss through venting after filling of the liquid hydrogen fuel storage tank and before delivery of the filled liquid hydrogen fuel storage tank to the hydrogen powered vehicle.

27. The computer-implemented system of claim 26, wherein the one or more processors are configured to further execute the computer-executable instructions in order to:
determine, by the computer-implemented system, distance and delivery schedule information for the liquid hydrogen fuel storage tank from the filling station to the hydrogen powered vehicle,
wherein the selected mass of liquid hydrogen is further based on the distance and delivery schedule information.

28. The computer-implemented system of claim 26, wherein the one or more processors are configured to further execute the computer-executable instructions in order to:
determine, by the computer-implemented system, a storage time period for storing the liquid hydrogen fuel storage tank after receiving liquid hydrogen and before transportation to and installation on the hydrogen powered vehicle,
wherein the selected mass of liquid hydrogen is further based on the storage time period.

29. The computer-implemented system of claim 26, wherein the one or more processors are configured to further execute the computer-executable instructions in order to:
communicate, by the computer-implemented system, the selected mass of liquid hydrogen to the filling station.

30. The computer-implemented system of claim 26, wherein the hydrogen powered vehicle is an aircraft, and wherein the one or more processors are configured to further execute the computer-executable instructions in order to:
communicate, by the computer-implemented system, an indication to the filling station that the filled liquid hydrogen fuel storage tank is to be delivered to the aircraft remote from the filling station.

31. The computer-implemented system of claim 26, wherein the liquid hydrogen fuel storage tank is included in a portable fuel module.

32. The computer-implemented system of claim 26, wherein the liquid hydrogen fuel storage tank comprises a portable, refillable hydrogen fuel tank, and wherein the liquid hydrogen fuel storage tank to be filled has been previously filled and depleted of liquid hydrogen fuel.

33. The computer-implemented system of claim 26, wherein the one or more processors are configured to further execute the computer-executable instructions in order to:
determine, by the computer-implemented system, environmental conditions at the hydrogen powered vehicle's location and the filling station,
wherein the selected mass of liquid hydrogen is further based on the environmental conditions.
